(19) United States
(12) Patent Application Publication
(10) Pub. No.: US 2010/0071819 A1
(43) Pub. Date: Mar. 25, 2010

(54) Solid Vacuum Tire and Wheel Assembly

(76) Inventor: Michael Marion McCulley, Benicia, CA (US)

Correspondence Address: Michael Marion McCulley, 597 Lori Drive, Benicia, CA, 94510, US

(21) Appl. No.: 12/584,443

(22) Filed: Sep. 8, 2009

Related U.S. Application Data
(60) Provisional application No. 61/192,834, filed on Sep. 23, 2008.

(51) Int. Cl. B60C 7/00; B60B 19/00

(52) U.S. Cl. 152/323; 152/246

(57) ABSTRACT

A solid vacuum tire and wheel assembly incorporating a vacuum backpressure to adhere the tire to the wheel hub, allowing it to achieve safe and reliable high-speed operation. The system incorporates a soft tire core that contracts into place after a vacuum is applied, contracting and adhering tight onto the wheel assembly hub by filling any void, and without unnecessary spare tire equipment and no air pressure to maintain. Vacuum channels in the wheel assembly hub direct and apply even vacuum backpressure to the tire. A vacuum valve is installed into a vacuum chamber, which acts as a conduit to direct vacuum pressure throughout the system. The tire incorporates a possible concave shaped tire tread configuration, comprised of common tire tread rubber and a steel belt. The inner tire core material comprising of solid or porous rubber, jell or a combination of materials provides a solid non-pneumatic core structure.

### FIELD OF THE INVENTION

The present invention relates generally to resilient tires and wheels.

### BACKGROUND OF THE INVENTION

Many conventional designs already exist for pneumatic wheel and tire assemblies for road going and air transportation. These conventional systems suffer several disadvantages. One disadvantage with pneumatic wheel and tire assemblies is that they can go flat or have a catastrophic failure such as a blowout. With a flat tire, a pneumatic wheel and tire assembly will require a repair or replacement before the vehicle can become operational again. With a blowout, on the other hand, a serious crash can occur that can cause injuries and possibly death to the occupants of the vehicle. Having air pressure to check and constantly maintain can also be a disadvantage of conventional systems, and a slow leak can go undetected. Low pressure can also have a negative impact on the fuel efficiency of the vehicle. The spare tire assembly is necessary with conventional designs, do to the fact that one tire may be flat and in need of repair, and the spare tire and jack equipment can additionally be a disadvantage in the overall weight of the vehicle. Moisture inside a pneumatic wheel and tire airspace can also cause corrosion over time. Another disadvantage with pneumatic wheel and tire assemblies is that they do not keep a constant pressure due to changing ambient temperatures, and this creates flux in operating conditions.

Conventional designs also already exist for solid wheel and tire assemblies. One disadvantage with conventional solid wheel and tire assemblies is that they often need to be attached to the wheel frame in order to stay in place. Another disadvantage is that solid wheel and tire assemblies tend to be large, ridged and heavy, and these assemblies cannot often achieve high-speed operation.

### SUMMARY OF THE INVENTION

The present invention incorporates a solid vacuum tire and wheel assembly that can overcome the disadvantages in conventional systems. The present invention is the first of its kind to incorporate a vacuum backpressure to adhere the tire to the wheel hub, and this advantage will allow it to achieve high-speed operation. There is no possibility that the tire and wheel assembly can go flat or have a blowout, since the present invention is non-pneumatic, and this advantage will provide for a much safer operation. A spare tire assembly is unnecessary with the present invention, and all jack equipment is also unnecessary. The advantage of the absence of unnecessary equipment will decrease the overall weight of the vehicle, which will in turn increase the performance of the vehicle as well as fuel efficiency. Another advantage will be no air pressure to check and constantly maintain in the present invention, and the new system will keep a constant operating vacuum backpressure over all operating conditions. There will additionally be no moisture inside the tire to cause corrosion over time due to the vacuum seal. The present invention can also be configured for an extremely lightweight low-profile system.

The present invention incorporates a soft tire core that will be able to contract into place after a vacuum is applied. With a vacuum applied to the system, the tire core contracts and adheres tight onto the wheel assembly hub for normal operation by filling any void around the wheel hub. Vacuum channels are located within the wheel assembly hub in order to direct and apply even vacuum backpressure to the tire. As the tire rotates, the vacuum will keep it strongly adhered to the wheel hub without separating at high speeds. The vacuum channels are distributed along the wheel hub as needed to achieve even backpressure seal. A vacuum valve is installed into a vacuum chamber, which acts as a conduit to direct vacuum pressure throughout the system. Airflow in ether direction can flow in and out of the vacuum valve body. The vacuum backpressure also keeps a valve stem seal in place during normal operation. To release vacuum pressure or to depressurize, a common screw in valve stem adapter can attach to the valve stem tip and pull the stem away form the valve body to release vacuum pressure or depressurize the system for normal vacuum operation.

The present invention can additionally incorporate a concave shaped tire tread configuration. This concave configuration is intended to increase stability in vehicle handling by creating a strong stable bond between the ground surface and the tire. This advantage will decrease tire roll associated with conventional systems. The tire sits flat on the ground surface with weight applied to the vehicle. The tire tread can be comprised of common tire tread rubber, and a common steel belt can be added for tire strength. The inner tire core material can be comprised of new materials that have the strength and resiliency to strongly adhere the tire to the wheel hub assembly and compress to the wheel hub, as well as keeping a constant backpressure vacuum seal. The inner tire core material can be comprised of solid or porous rubber, jell or a combination of materials and will provide a solid non-pneumatic core structure. An object such as a nail would be able to penetrate into the tire tread, core or sidewall without the tire losing any air such as in conventional systems, and this will create an extremely safe and reliable tire.

### BRIEF DESCRIPTION OF THE FIGURES

FIG. 1 represents a cross section of the solid vacuum tire and wheel assembly before and after a vacuum is applied to the system.

FIG. 2 represents a cross section of the vacuum wheel assembly with vacuum channels and vacuum valve installation, as well as a front and side view.

FIG. 3 represents the vacuum valve assembly, front and side view, as well as a cross section of the vacuum valve assembly and valve stem.

FIG. 4 represents a cross section of the solid vacuum tire and wheel assembly with a concave shaped tire tread configuration, as well as the tire tread position on the ground surface.

### DETAILED DESCRIPTION OF THE FIGURES

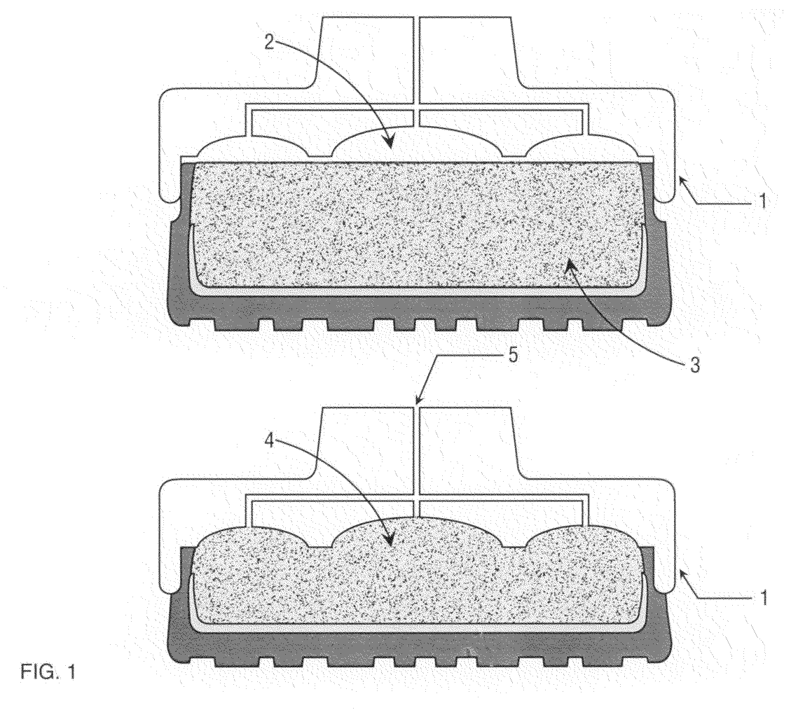

FIG. 1 represents a cross section of the solid vacuum tire and wheel assembly before and after a vacuum is applied to the system. The space 2 between the wheel assembly 1 and the tire 3 is present before there is a vacuum applied to the system. The soft core of the tire 3 will be able to contract into place after a vacuum is applied. With a vacuum applied to the system, the tire core 4 contracts and adheres tight onto the wheel assembly 1 for normal operation. The vacuum channels 5 are located within the wheel assembly hub in order to direct and apply vacuum pressure to the tire.

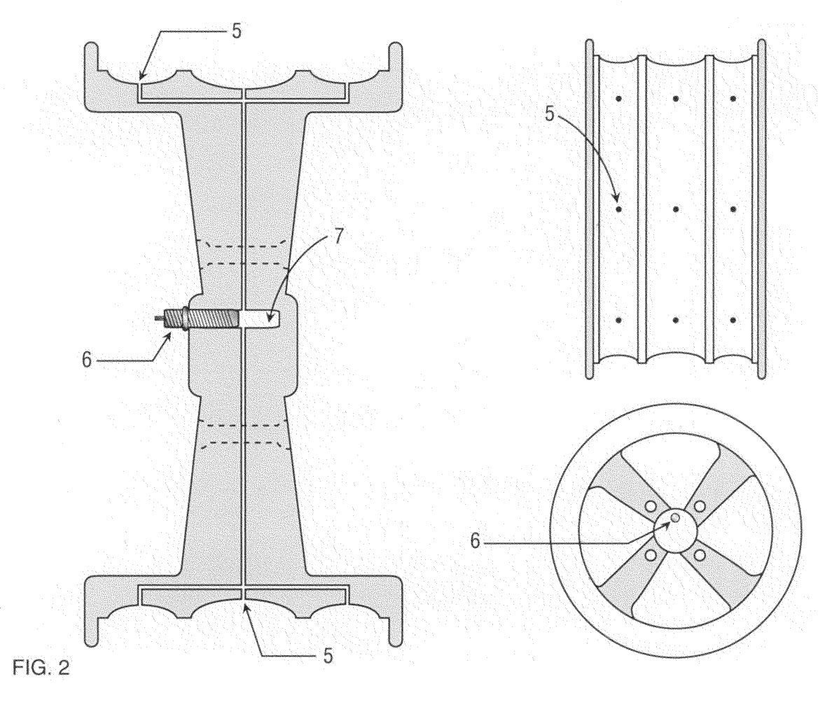

FIG. 2 represents a cross section of the vacuum wheel assembly with vacuum channels and vacuum valve installation, as well as a front and side view. The vacuum channels 5 are located within the wheel assembly in order to direct and apply vacuum pressure to the tire. The vacuum channels 5 are distributed along the wheel hub as needed to achieve even backpressure. A vacuum valve 6 is installed into the vacuum chamber 7, which acts as a conduit to direct vacuum pressure throughout the system.

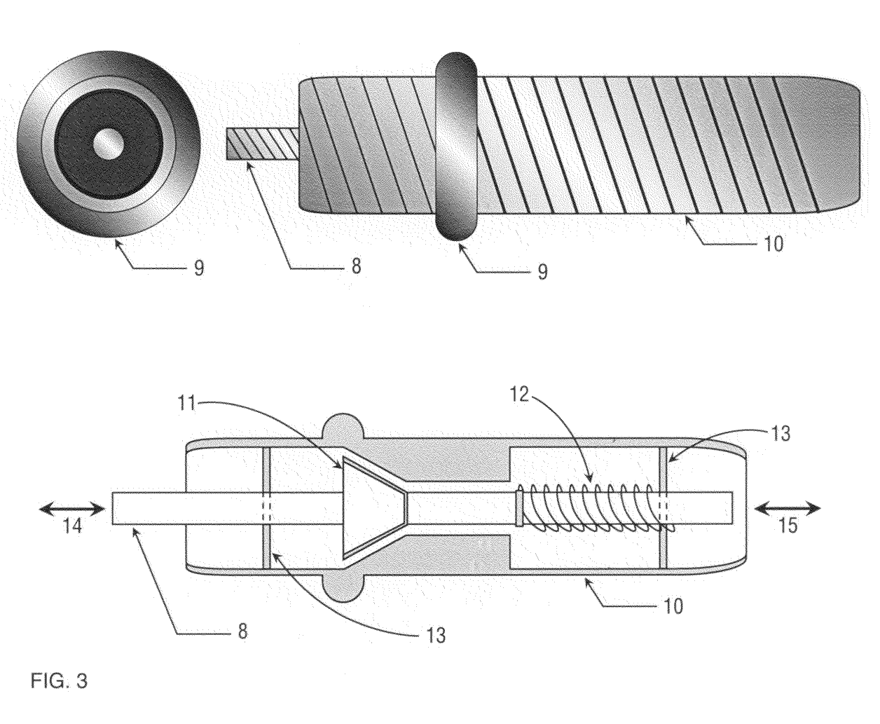

FIG. 3 represents the vacuum valve assembly, front and side view, as well as a cross section of the vacuum valve assembly with valve stem. The valve stem tip 8 is pulled away from the vacuum valve body 10, which releases a vacuum seal 11. Arrows at the front of the valve body represent the valve stem motion 14, and air can also flow in and out through the valve body 10. A spring 12 keeps the valve stem seal 11 tight against the valve body 10. Two brackets 13 hold the valve stem in place. Airflow in ether direction 15 is represented by arrows and can also flow in and out of the back of the valve body 10. The vacuum backpressure also keeps the valve stem seal 11 in place during normal operation. To release vacuum pressure, a common screw in valve stem adapter can attach to the valve stem tip 8 and pull the stem away form the valve body 10 to let air into the system. The valve body 10 is installed into the wheel assembly hub in front of the vacuum chamber 7, herein FIG. 2, and is held in place by a ring seal 9.

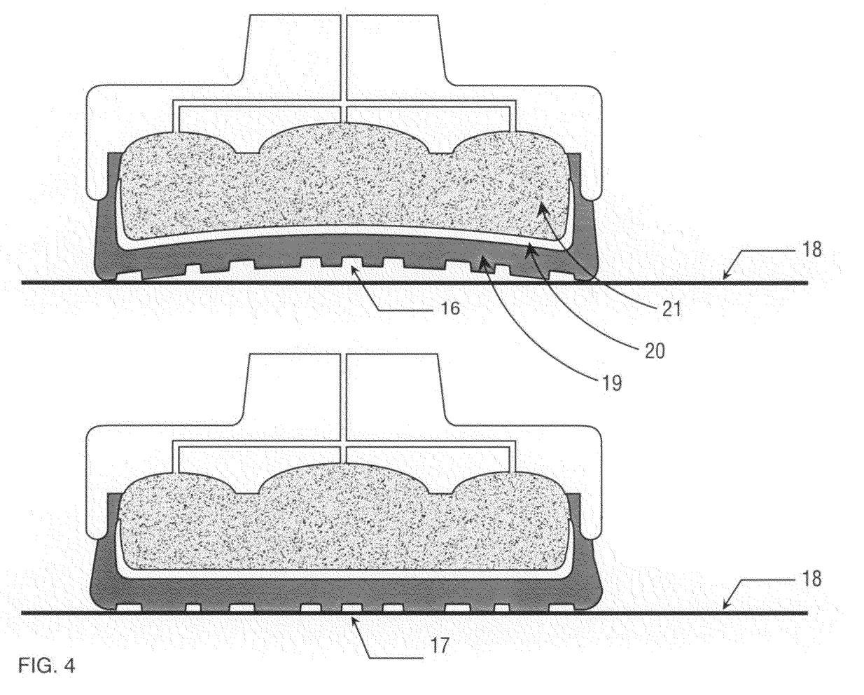

FIG. 4 represents a cross section of the solid vacuum tire and wheel assembly with a concave shaped tire tread configuration, as well as the tire tread position on the ground surface. The concave shaped tire tread configuration 16 is intended to increase stability in vehicle handling by creating a strong stable operational platform for the ground surface 18 and the tire. The tire sits flat 17 on the ground surface 18 with weight applied to the vehicle. The tire tread 19 can be comprised of common tire tread rubber, and a common steel belt 20 can be added for tire strength. The inner tire core material 21 can be comprised of soft rubber or new materials that have the strength and resiliency to strongly adhere the tire to the wheel hub assembly and also compress to the wheel hub while keeping a constant backpressure vacuum seal. The inner tire core material 21 may be comprised of solid or porous materials and will provide a solid flexible tire core. The inner tire core material 21 can be comprised of solid or porous rubber, jell or a combination of materials and will provide a solid non-pneumatic core structure.

What is claimed is:

1. A solid vacuum tire and wheel assembly, comprising: a solid vacuum tire, wherein the soft core of the tire will be able to contract into place while a vacuum is applied, wherein the tire core contracts and adheres tight onto the wheel assembly hub for normal or high-speed operation after a vacuum is applied to the system, wherein vacuum channels located within the wheel assembly hub direct and apply vacuum pressure by filling any void between the tire core and wheel hub in the present invention.

2. The solid vacuum tire and wheel assembly of claim 1, wherein vacuum channels are located within a wheel assembly hub in order to direct and apply vacuum pressure to the tire, wherein the vacuum channels are distributed along the wheel hub as needed to achieve an even backpressure between the tire core and wheel hub, wherein a vacuum valve assembly of claim 4 is installed into a vacuum chamber inside the wheel assembly, which acts as a conduit to direct vacuum pressure throughout the system, wherein the tire can be removed by releasing the vacuum pressure from the wheel assembly.

3. The solid vacuum tire and wheel assembly of claim 1, wherein a concave shaped tire tread configuration can increase stability in vehicle handling by creating a strong stable operational platform between the ground surface and the tire, wherein the tire sits flat on the ground surface with weight applied to the vehicle, wherein the tire tread can be comprised of common tire tread rubber, wherein common steel belts can be added for additional tire strength, wherein the inner tire core material can be comprised of soft rubber or new materials that have the strength and resiliency to strongly adhere the tire to the wheel assembly hub and also compress the tire to the wheel hub while keeping a constant backpressure vacuum seal, wherein the inner tire core material can be comprised of solid or porous materials and will provide a solid flexible tire core, wherein the inner tire core material can be comprised of solid or porous rubber, jell or a combination of materials and will provide a solid non-pneumatic tire core structure.

4. A vacuum valve assembly, comprising: a vacuum valve stem tip which is pulled away from a vacuum valve body which releases a vacuum seal, wherein air can flow in and out through the valve body, wherein a spring keeps the valve stem seal tight against the valve body, wherein brackets hold the valve stem in place, wherein airflow in ether direction can also flow in and out of the back of the valve body, wherein vacuum backpressure also keeps the valve stem seal in place during normal operation, wherein the release of vacuum pressure can be achieved by the use of a screw in valve stem adapter that can attach to the valve stem tip and pull the stem away form the valve body to let air into the system, wherein the valve body is installed into the solid vacuum tire and wheel assembly of claim 1 and is installed in front of a vacuum chamber, wherein the valve body can be held in place by a ring seal or threaded into the wheel assembly of claim 1.
